(19) United States
(12) Patent Application Publication
(10) Pub. No.: US 2018/0057283 A1
(43) Pub. Date: Mar. 1, 2018

(54) AUTONOMOUS ROBOT AND METHODS FOR LIFTING AND STACKING PACKAGES

(71) Applicants: Robert PETERS, St. Catharines (CA); Ken GIESBRECHT, Jordan Station (CA); Chris LYDDIATT, St. Catharines (CA); Sean SEMPLE, St. Catharines (CA); Matthew PLUMB, Georgetown (CA); Chanh Vy TRAN, Mississauga (CA); Andrew BARKER, Oakville (CA); Matthew James SERGENESE, Thorold, CA (US)

(72) Inventors: Robert PETERS, St. Catharines (CA); Ken GIESBRECHT, Jordan Station (CA); Chris LYDDIATT, St. Catharines (CA); Sean SEMPLE, St. Catharines (CA); Matthew PLUMB, Georgetown (CA); Chanh Vy TRAN, Mississauga (CA); Andrew BARKER, Oakville (CA); Matthew James SERGENESE, Thorold, CA (US)

(21) Appl. No.: 15/254,523

(22) Filed: Sep. 1, 2016

(51) Int. Cl. B65G 57/02; B65G 1/04; G05D 1/02

(52) U.S. Cl. CPC B65G 57/02; G05D 2201/0216; G05D 1/021; B65G 1/0421

(57) ABSTRACT

An autonomous robot and methods are provided for lifting and stacking packages, such as on a shelf in a warehouse. The robot comprises a base, an elevator assembly that raises and lowers an elevator platform, an engagement mechanism for attaching the robot to a shelf, and steerable drive mechanisms for driving the robot in any direction (e.g. both forward and laterally) on a warehouse floor. The robot is navigated to a storage location of a package. The robot is driven laterally towards the shelf without rotating the robot or elevator platform, and is then clamped to the shelf. The elevator platform is then raised to the height of the package. The package is moved from the storage location to the elevator platform with a gantry.

### TECHNICAL FIELD

The disclosure herein relates to autonomous robots, and in particular, to autonomous robots for lifting and stacking packages, such as in a warehouse.

### BACKGROUND

The application of autonomous robot technology towards industrial and commercial warehouses and fulfillment centers has been found to improve the productivity of storing, retrieving, and shipping inventory within warehouse and fulfillment center environments. These autonomous robots operate with a relatively high degree of autonomy within degrees of freedom that are defined by the particular environment of a warehouse or fulfillment center.

Currently, robots are used to assist human pickers working in warehouses and fulfillment centers. In this way, when a particular item is required in order to fulfill an order, the robot is driven to the location where the item is stored on the shelf, and, in some cases, identifies the product to be picked. The human picker then picks up the item, and places it on the robot.

Other systems may use autonomous robots to navigate to a desired item, and to retrieve the item from a shelf. However, these systems rely on specialized storage containers or totes with a specific size and shape selected for use with the particular robot. The size is selected not only to ensure that the length, height, or width of the container or tote is not too big to be held by the robot, but also to ensure that the container will not contain items that are too heavy for the robot to lift or carry. These systems require specialized mechanical interfacing between the robot and the storage container that holds the desired item. Furthermore, these systems require specialized shelving that is limited to a height that is lower than the height of a shelf or rack that would otherwise be inaccessible by the robot. Thus, the use of such a system is limited to relatively small, light-weight packages, and does not make efficient use of the vertical space that exists within a warehouse. Furthermore, other systems are restricted to only moving pallets without containers or totes.

Furthermore, these systems rely on specialized, custom, or purpose-built warehouse infrastructure that is costly to build, install, and maintain. Once specialized, custom, or purpose-built infrastructure is installed in a warehouse, it does not allow for flexibility in regards to the use of new or different sizes and shapes of items or containers.

### BRIEF DESCRIPTION OF THE DRAWINGS

Some embodiments of the present disclosure will now be described, by way of example only, with reference to the following drawings, in which:

FIG. 1 is a perspective view of an example warehouse shelf in an aisle;

FIG. 2 is a block diagram of systems and subsystems of an autonomous robot for lifting and stacking packages, according to some embodiments.

FIG. 3A is perspective view of an autonomous robot for lifting and stacking packages in a lowered position, according to some embodiments;

FIG. 3B is a perspective view of the autonomous robot of FIG. 3A in a raised position, according to some embodiments;

FIG. 3C is a side view of a portion of the autonomous robot of FIG. 3A, according to some embodiments;

FIG. 3D is a perspective view of the autonomous robot of FIG. 3A showing an elevator brake mechanism;

FIG. 4 is a perspective view of a steerable drive mechanism assembly according to some embodiments;

FIG. 5 is a diagram depicting various embodiments of an elevator assembly;

FIG. 6 is a perspective view of a gantry for use on an autonomous robot, according to some embodiments;

FIG. 7 is a perspective view of an engagement mechanism according to some embodiments;

FIG. 8 is a flow diagram depicting a method for lifting a package off of a shelf, according to some embodiments; and

FIG. 9 is a flow diagram depicting a method for stacking a package on a shelf, according to some embodiments.

### DETAILED DESCRIPTION

Various apparatuses or processes will be described below to provide an example of an embodiment of each claimed invention. No embodiment described below limits any claimed invention and any claimed invention may cover processes or apparatuses that differ from those described below. The claimed inventions are not limited to apparatuses or processes having all of the features of any one apparatus or process described below or to features common to multiple or all of the apparatuses described below. It is possible that an apparatus or process described below is not an embodiment of any claimed invention. Any invention disclosed below that is not claimed in this document may be the subject matter of another protective instrument, for example, a continuing patent application, and the applicants, inventors or owners do not intend to abandon, disclaim or dedicate to the public any such invention by its disclosure in this document.

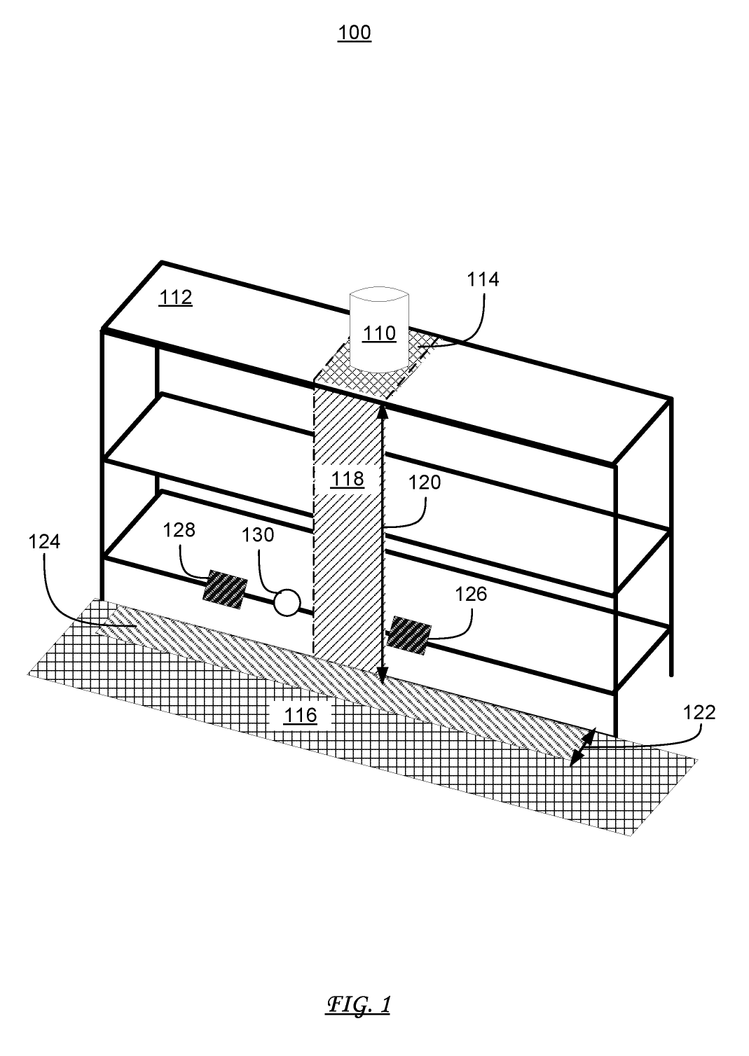

Referring to FIG. 1, there is shown an example warehouse space 100. Located within the warehouse 100 is a package 110 on a shelf 112 within a storage location 114. The storage location 114 is an area on the plane of a horizontal surface of the shelf 112.

The storage location 114, in which the package 110 is located on the shelf 112, is associated with a particular aisle location 116. The warehouse 100 may include multiple aisle locations 116, each with a unique identification. Therefore, a particular package 110 may be found by first locating its associated aisle location 116. Generally speaking, an aisle location 116 is an area on the plane of the warehouse floor.

The storage location 114 is also associated with a particular shelf location 118. Once the aisle location 116 associated with a particular package 110 has been located, the particular package 110 may be found by locating its associated shelf location 118. The shelf location 118 is a particular area along the face of the shelf 112, and is generally perpendicular (vertical) to the aisle location 116.

The storage location 114 is also associated with a particular storage height 120. Once the shelf location 118 associated with a particular package 110 has been located, the particular package 110 may be found at the storage height 120, within the shelf location 118.

An autonomous robot for lifting and stacking the package 110 may be designed to operate with the shelf 112 at a shelf-access distance 122. A shelf-access area 124 is also defined, which may or may not be based on the shelf-access distance 122. For example, the robot may include a reader or sensor for reading or sensing location identifiers 126 and 128. Therefore, the robot may be required to drive within the shelf-access area 124 in order for the reader or sensor to be able to read or sense the location identifiers 126 and 128.

Furthermore, the robot may include an engagement mechanism, which may be used with a docking member 130 located on the shelf. Therefore, the robot may be required to be located at a distance from the shelf determined by the shelf-access distance 122 in order for the robot to be successfully clamped to the shelf 112. In some cases, the robot may include an engagement mechanism that can clamp to any standard shelf, or which does not otherwise require a docking member 130 in order to clamp to the shelf 112.

The robot may be equipped with an aisle navigation system that includes a distance sensor in order to determine the distance from the robot to the shelf 112, for example, with respect to the shelf-access distance 122, and/or the shelf-access area 124.

Multiple location identifiers (e.g. location identifier 126 and location identifier 128) may be placed on the shelf 112. For example, the location identifier 126 may be used in conjunction with the inventory management system 210 to retrieve information pertaining to the package 110 and/or the storage location 114, and may therefore be placed in or adjacent to the shelf location 118. The location identifier 128 may be placed in or adjacent to a different shelf location (not shown).

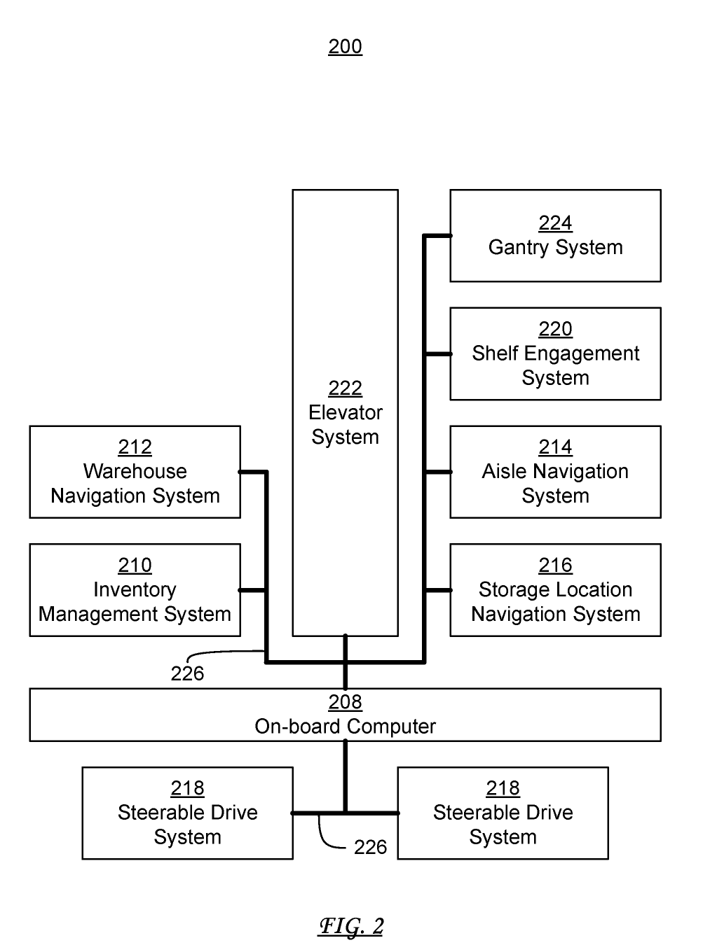

Referring to FIG. 2, there is shown a block diagram depicting various systems and subsystems of an autonomous robot for lifting and stacking packages 200, according to some embodiments. The robot 200 may be one of many distributed robot vehicles that is part of a distributed robot system.

The robot 200 comprises an onboard computer system 208, an inventory management system 210, a warehouse navigation system 212, an aisle navigation system 214, a storage-location navigation system 216, a steerable drive system 218, a shelf-engagement system 220, an elevator system 222, and a gantry system 224. These systems (and subsystems) may generally communicate with each other via a system bus 226.

The embodiments of the systems and methods described herein may be implemented in hardware or software, or a combination of both. However, preferably, these embodiments are implemented in computer programs executing on programmable computers of which the onboard computer system 208 is exemplary. The onboard computer system 208 comprises at least one processor, a data storage system (including volatile and non-volatile memory and/or other storage elements), at least one input device, and at least one output device. For example and without limitation, the onboard computer system 208 may be a programmable electronic controller, mainframe computer, server, personal computer, laptop, or embedded computers. Various computing tasks may be performed by computers attached to the robot 200, and/or distributed in a warehouse and accessible to the robot, for example, via the inventory management system 210. Program code is applied to input data to perform the functions described herein and generate output information. The output information is applied to one or more output devices, in known fashion.

Each program may be implemented in a high level procedural or object oriented programming and/or scripting language to communicate with a computer system. However, the programs can be implemented in assembly or machine language, if desired. In any case, the language may be a compiled or interpreted language. Each such computer program is preferably stored on a storage media or a device (e.g. read only memory (ROM) or magnetic diskette) readable by a general or special purpose programmable computer, for configuring and operating the computer when the storage media or device is read by the computer to perform the procedures described herein. The inventive system may also be considered to be implemented as a computer-readable storage medium, configured with a computer program, where the storage medium so configured causes a computer to operate in a specific and predefined manner to perform the functions described herein

An inventory management system may generally be implemented over a network available to the robot 200, and the inventory management system 210 as depicted in FIG. 2 may represent a component of a larger inventory management system that is implemented over a network.

For example, the inventory management system 210 may comprise or interface with an enterprise resource planning system that may include the integration of several different aspects of business management, such as marketing, sales, ordering, purchasing, inventory management, order fulfillment, shipping, and delivery. As such, the inventory management system 210 may be integrated with other aspects of the business, as well as with other business organizations such as partners, suppliers, customers, and logistics providers.

The inventory management system 210 may be used to receive and process a request for packages to be moved within the warehouse 100. For example, the inventory management system 210 may receive a request to retrieve a particular package 110 from a particular storage location 114. The inventory management system 210 may determine a target package 110, a storage location 114, an aisle location 116, and/or a shelf location 118 based on the relationships that may be defined between these data. For example, the request may be to retrieve a particular package 110 (in which case the inventory management system 210 may determine the associated storage location 114, aisle location 116, shelf location 118, etc.). In other cases, the request may be to deliver a package to a particular storage location 114. In any case, the inventory management system 210 generally provides a target or objective to the robot 200.

Based on the target or objective, the robot 200 can use the warehouse navigation system 212 to drive the robot from one location in the warehouse to another, using the steerable drive system 218. For example, the robot 200 may be located at a particular terminal or charging station within the warehouse, or at a particular shelf location (e.g. as associated with a previous target or objective) when a new target or objective is ready for execution.

In the event that the new target or objective requires the robot to move to a new aisle within the warehouse, the warehouse navigation system 212 can be used. The warehouse navigation system may comprise a vision-based system using optical sensor(s) and navigational target signs placed throughout the warehouse. In other cases, the warehouse navigation system may comprise a track in the warehouse floor (e.g. a metal track, or a line applied to the floor with paint or tape) such that the steerable drive system 218 is used to drive the robot 200 along the track. The warehouse navigation system 212 may also include a laser-based navigation system using triangulation via reflective tape markers placed throughout the warehouse, and/or simultaneous localization and mapping (SLAM) technology that uses 3D cameras and/or laser guidance and an overall warehouse map.

The warehouse navigation system 212 may be used to drive the robot 200 to a particular aisle location 116, at which point, navigation of the robot 200 may be handed off to the aisle navigation system. Additionally, or alternatively, the warehouse navigation system 212 may be used to drive the robot 200 to a particular shelf location 118 within an aisle location 116.

Once the robot 200 has been driven to the aisle location 116 corresponding to the target or objective, the aisle navigation system 214 may be used to navigate the robot to the shelf location 118. For example, the aisle navigation system 214 may comprise a reader or sensor (e.g. a barcode scanner or RFID sensor) for obtaining information from a location identifier 126 (e.g. a barcode or RFID tag) placed along the shelf or within the aisle location 116. For example, as the robot 200 is driven past a location identifier 126, the information can be obtained from the location identifier 126, and the aisle navigation system 214 can determine the position of the robot 200 within the aisle location 116. Furthermore, the aisle navigation system may comprise a distance sensor (e.g. an ultrasonic distance sensor or optical distance sensor) for determining the distance from the robot 200 to the shelf. The distance sensor may be used by the aisle navigation system 214 to ensure that the robot 200 is travelling generally parallel to the shelf, and/or that the robot 200 is at a suitable distance from the shelf for obtaining information from the location identifier 126.

Once the robot 200 has been driven to the shelf location 118 corresponding to the target or objective, the storage-location navigation system 216 may be used to position the robot 200 so that the target or objective can be achieved (e.g. a package 110 can be retrieved from or placed in a particular storage location 114).

The storage-location navigation system 216 may comprise an information reader or sensor and/or a distance sensor (e.g. an ultrasonic distance sensor or optical distance sensor). The information reader or sensor may be used to information from the location identifier 126 at the target shelf location 118 in order to obtain further information related to the target package 110 or storage location 114 (as the case may be). For example, the storage-location navigation system 216 may obtain information from the location identifier 126 in order to verify that the target package 110 or storage location 114 (as the case may be) is actually in the expected location. Furthermore, the robot 200 may obtain details such as the exact height of the package 110 or storage location 114, lateral offset on the shelf, package size and weight, package description, and/or further instructions related to the package 110 and/or storage location 114.

In order to prepare the robot 200 for stacking or retrieving the package 110 on the storage location 114, the storage-location navigation system 216 may adjust the distance from the robot 200 to the shelf using the steerable drive system 218. For example, it may be necessary or desirable for the robot 200 to be within a shelf-access area 124, or to be separated from the shelf by the shelf-access distance 122.

In order to position the robot 200 at an appropriate distance from the shelf, and in order to ensure that the robot 200 is properly aligned with the shelf, the storage-location navigation system 216 may use the steerable drive system 218 to drive the robot 200 laterally towards the shelf. Whereas the warehouse navigation system 212 and aisle navigation system 214 generally use the steerable drive system 218 to drive the robot forwards (and backwards), the storage-location navigation system 216 may use the steerable drive system 218 to drive the robot 200 laterally (sideways) in order to drive the robot 200 towards the shelf without substantially rotating the body of the robot 200. The warehouse navigation system 212 and the aisle navigation system 214 may also use the steerable drive system 218 to drive the robot 200 laterally.

Once the robot 200 has been properly positioned at the shelf location 118, the elevator system 222 may be used to raise an elevator assembly (e.g. having an elevator platform) of the elevator system 222 and/or a gantry of the gantry system 224 to the height of the package 110 or storage location 114 (as the case may be).

In some cases, the height of the elevator assembly may be determined based on the height of the storage location 114, which may include accounting for the height of individual packages 110 stored at the storage location 114, or the height of packages on the elevator platform. For example, if a target package is being moved from the elevator platform to the storage location 114, and the target package is stacked on top of one or more packages on the elevator platform, then the elevator system 222 may raise the elevator assembly such that the elevator platform is offset below the storage location 114 by the height of the packages on which the target package is stacked. In other words, the elevator system 222 may raise the elevator assembly so that the target package is at the height of the storage location 114. According to some embodiments, the height of the packages may be received from the inventory management system.

Similarly, if a target package is being moved from the storage location 114 to the elevator platform, and the target package is to be stacked on top of one or more packages on the elevator platform, then the elevator system 222 may raise the elevator assembly such that the elevator platform is offset below the storage location 114 by the height of the packages on which the target package is to be stacked. According to some embodiments, the height of the packages may be received from the inventory management system.

Once the robot 200 has been properly positioned at the shelf location 118 corresponding to the target or objective, and the elevator assembly has been raised to the desired height, the shelf engagement system 220 is deployed in order to secure the robot 200 to the shelf. The shelf engagement system may include an engagement mechanism in order to clamp the robot 200 to the shelf, and thereby secure the position of the robot and provide stability to the robot 200 while the elevator assembly is being operated.

According to some embodiments, such as in cases where the engagement mechanism is not attached to the elevator platform, it may be possible for the shelf engagement system 220 to be deployed prior to the elevator assembly being raised.

Once the elevator system 222 has raised the elevator assembly to the desired height, the gantry system 224 may be used to retrieve the package 110 from the storage location 114, or to place the package 110 onto the storage location 114 (as the case may be). The gantry system 224 may use the lateral offset of the package on the shelf, the package size, weight, description, and/or further instructions, in order to retrieve the package 110 from the storage location 114, or to place the package 110 onto the storage location 114.

The storage-location navigation system 216 may include one or more optical sensors (e.g. cameras, 3D scanners or 3D-enabled cameras and sensors) mounted on the gantry or elevator platform in order to identify the package 110, the storage location 114, and/or the adjacent area on the shelf.

The system bus 226 is used to allow the various subsystems and controllers (e.g. within the steerable drive system 218, the elevator system 222, the gantry system 224, etc.) to communicate with the onboard computer 208 and each other. For example, the system bus 226 may use a message-based protocol such as a Controller Area Network bus (CAN bus).

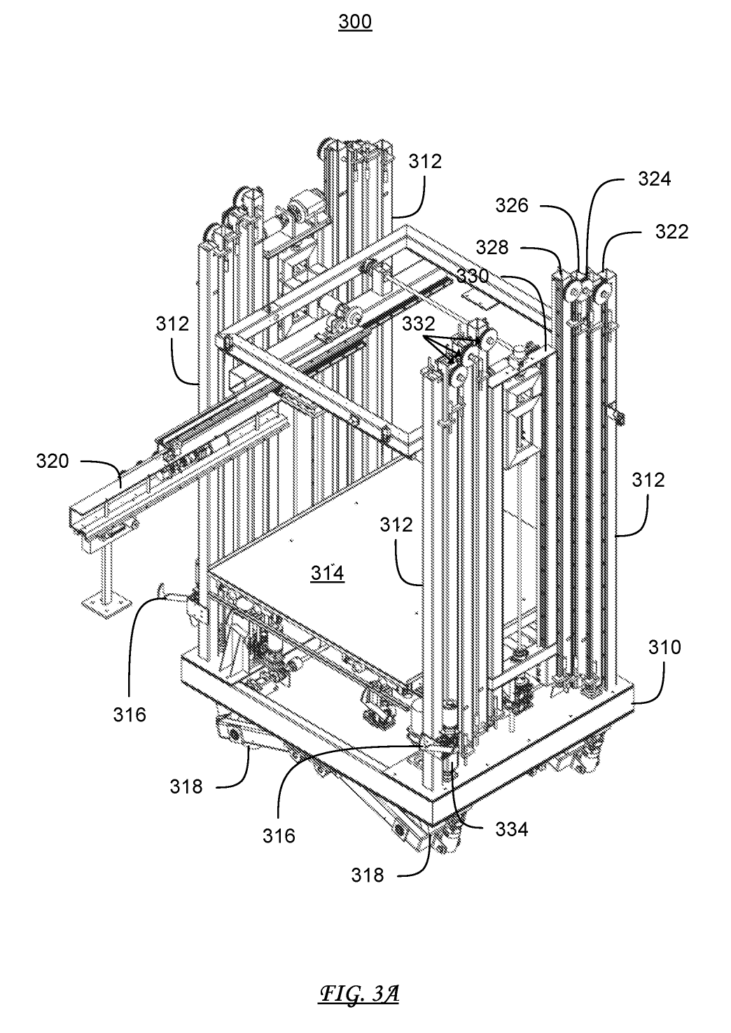

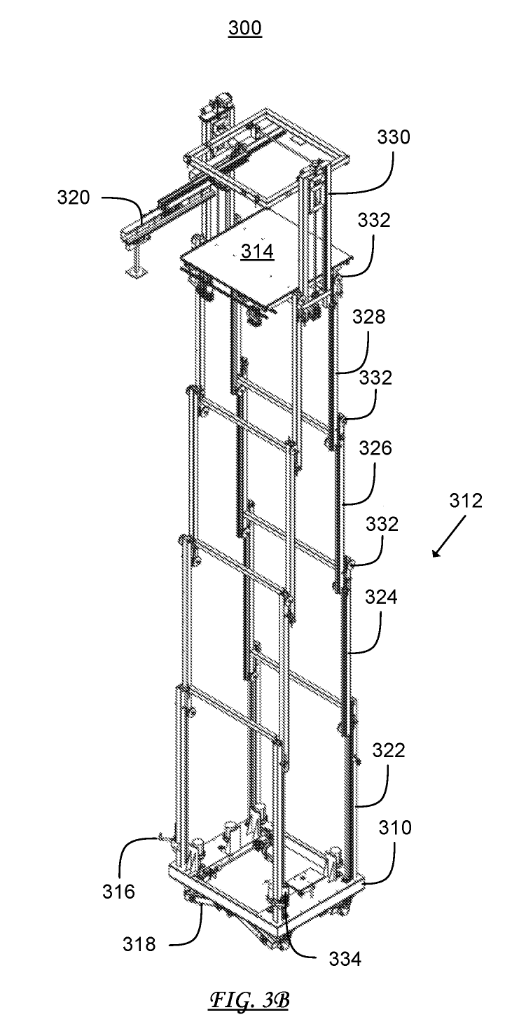

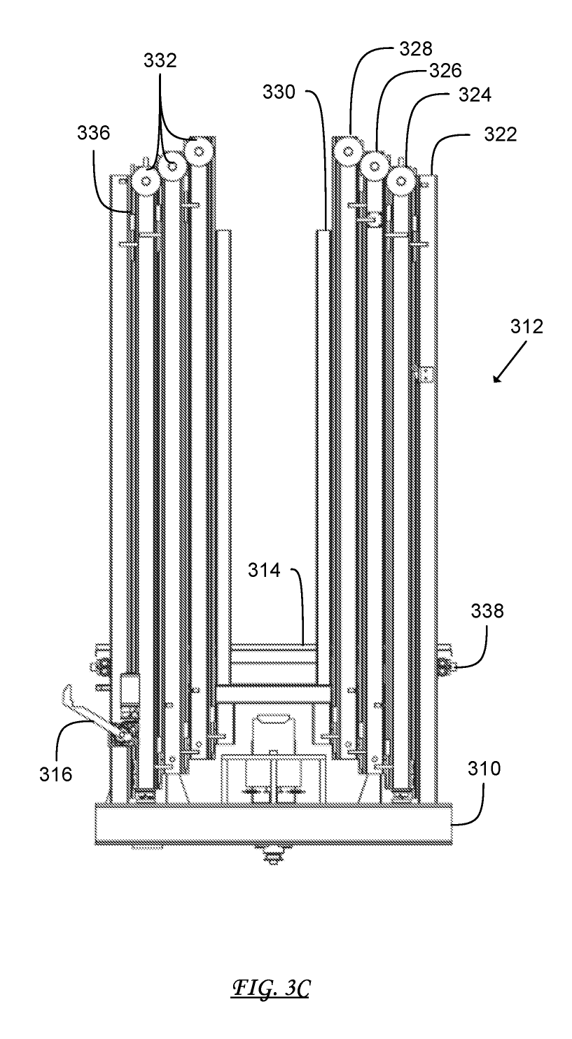

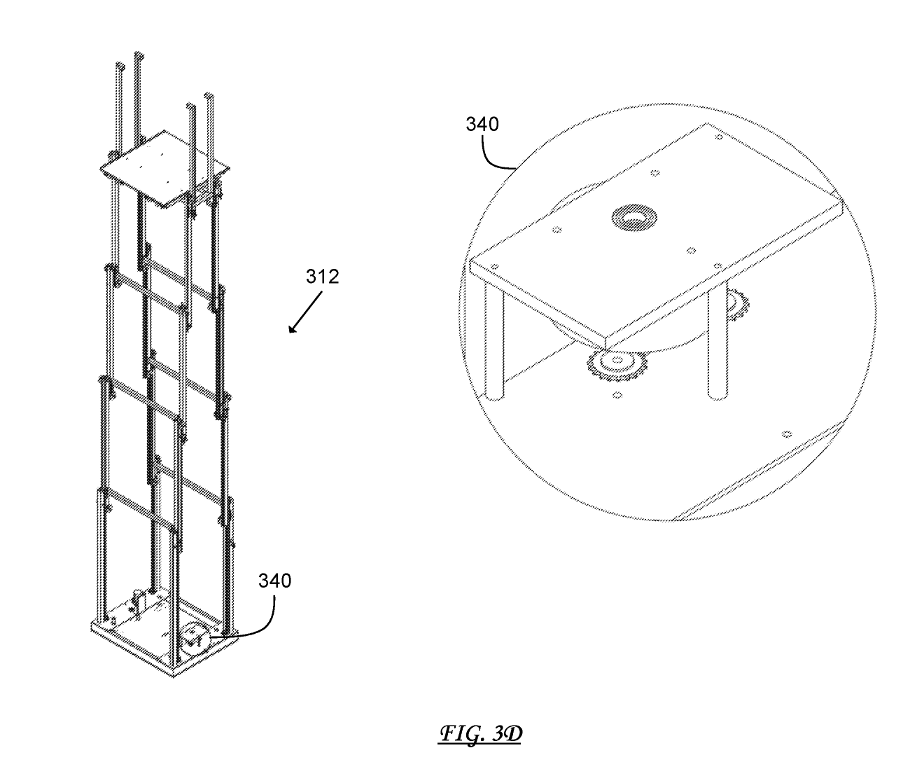

Referring to FIG. 3A and FIG. 3B, robot 200 may take the form of an autonomous robot 300 for lifting and stacking packages, according to some embodiments.

In FIG. 3A, the robot 300 is shown in a lowered position, such as may be suitable for traveling from one aisle location to another, or from one shelf location to another, with or without a package payload. In FIG. 3B, the robot 300 is shown in a raised position, such as may be suitable for use within a shelf location, for stacking a package on a storage location, or for lifting a package from a storage location.

The robot 300 comprises a base 310, an elevator assembly 312, and an elevator platform 314 that can be raised or lowered using the elevator assembly 312. Additionally, the robot may comprise an engagement mechanism 316, a steerable drive mechanism 318, and a gantry 320.

Various types of elevator assembly 312 may be used. For example, the elevator assembly 312 may comprise a multi-stage lift using a pulley or chain-style drive. Alternatively (or additionally), the elevator assembly 312 may comprise an electric, pneumatic, or hydraulic drive. In some cases, the elevator assembly may comprise a scissor lift, a rigid-chain actuator, a lift via a telescoping linear actuator, and/or another actuator such as a Spiralift™ helical band actuator.

As shown in FIG. 3A to FIG. 3C, the elevator assembly 312 may comprise four sets of vertical members and pulley-and-cable assemblies distributed on the base 310 in each of the four corners of the base 310, as shown. Each set of vertical members of the elevator assembly may comprise a set of multiple vertical members, such as vertical member 322, vertical member 324, vertical member 326, vertical member 328, and vertical member 330. Each of the vertical members may have one or more pulleys 332, which may be arranged in a pulley-and-cable assembly. According to some embodiments, a chain may be used in place of (or in addition to) a cable.

The elevator assembly 312 may comprise an elevating mechanism 334 that is attached to one of the vertical members, such as the vertical member 324.

As shown in the example of FIG. 3A to FIG. 3C, the elevating mechanism 334 may comprise a leadscrew drive. A leadscrew drive may be implemented, for example, using a leadscrew (also known as a power screw or a translation screw) that engages with a complementary thread within a vertical member. As such, when the leadscrew is turned in a first direction, the threaded engagement causes the vertical member to rise. When the leadscrew is turned in a second direction, the threaded engagement causes the vertical member to be lowered.

In addition to the leadscrew, the leadscrew drive may comprise a motor for turning the leadscrew, as well as means for coupling the motor with the leadscrew. For example, in some embodiments, a single motor may be used to drive multiple leadscrews (e.g. one leadscrew per set of vertical members, with multiple sets of vertical members), and each leadscrew may be coupled to the motor by a belt, chain, shaft, or other drive assembly.

Other examples of elevating mechanisms may use any or all of a pneumatic actuator, hydraulic actuator, rigid chain actuator, or a telescoping linear actuator.

The sets of multiple vertical members, arranged in a pulley-cable assembly, and powered by the elevating mechanism 334, allow the elevator platform 314 to be raised higher than traditional elevator assemblies, and, furthermore, to maintain the stability of the elevator platform 314 and the robot 300 even when the elevator platform 314 is raised to the full extent of the elevator assembly 312 while loaded with a heavy package. As the elevating mechanism 334 is turned (e.g. a leadscrew is turned by a motor), it forces the vertical member 324 to rise. As the vertical member 324 is raised upwards, it in turn forces the vertical members 326, 328, and 330 to rise, according to the pulley-cable assembly that comprises pulleys 332 and cables 336.

Alternatively, the elevating mechanism 334 may be attached to the first vertical member 322. In this case, the end of the cable 336 may be attached to the base of the robot such that, as the vertical member 322 is raised upwards, it in turn forces the vertical members 324, 326, 328, and 330 to rise, according to the pulley-cable assembly.

The elevator platform 314 is connected to the bottom of the vertical members 330, and the gantry 320 is connected to the top of the vertical members 330.

FIG. 3B shows the robot 300 with the elevator assembly 312 in its fully-extended position. In this position, the elevator platform 314 is raised to a height that is approximately four times higher than the height of the robot in its lowered position as shown in FIG. 3A. The vertical member 330 extends above the elevator platform 314, such that the gantry 320 can be positioned above the elevator platform 314.

With the configuration shown in FIG. 3A and FIG. 3C, the robot 300 can be placed in a lowered position that makes it suitable for travelling through a warehouse while transporting a package. For example, the lowered position provides greater stability for when the robot 300 is transporting a heavy package, and the lowered position provides easier navigation with respect to over-head obstacles.

Furthermore, when the elevator assembly 312 is in the lowered position, the elevator platform 314 is in a low position relative to the ground and a storage location with a relatively small height. As the elevator assembly 312 is raised by the elevating mechanism 334 (e.g. as the leadscrew is turned), the elevator platform 314 is raised at a relatively constant rate, with stability, all the way to the top of the extension range. (In the example shown, with vertical members 322 to 328, the extension range is effectively four times the height of each vertical member. The extension range could be increased by adding more vertical members, or increasing the height of a particular vertical member).

In this way, the robot 300 is able to accommodate any height associated with a storage location that is within the extension range. For example, the robot 300 is not dependent on any particular type of shelf, shelf height, or shelf spacing, so long as the shelf height is within the extension range.

The engagement mechanism 316 may be attached to the elevator platform 314 or the base 310 (or attached elsewhere on the robot 300) in order to secure the robot 300 to a shelf. The engagement mechanism 316 may serve to provide stability to the robot 300 when deploying or retrieving packages using the gantry 320. In some cases, the use of the engagement mechanism 316 can increase the height to which the elevator platform 314 can be raised, due to the added stability.

The term “steerable drive mechanism”, as used to describe the steerable drive mechanisms 318, means that the mechanism (e.g. individual wheels or a set of wheels organized to work in concert) is capable of providing both a driving force, as well as steering capabilities. This is different, for example, from a four-wheel configuration in which two wheels (the “drive” wheels) provide a driving force (i.e. forwards or backwards) and the other two wheels provide steering, such as by pivoting. For example, in a steerable drive mechanism, each individual wheel may provide its own driving force, and each wheel may be capable of steering the robot. In some cases, each wheel may be capable of steering the robot (e.g. each drive wheel may be capable of pivoting). In other cases, the combination of different driving forces on each wheel may be combined to drive the robot in any particular direction, even though any particular wheel may not be pivoting.

By using the steerable drive mechanism 318, the robot 300 can be driven along the length of a shelf (i.e. down an aisle) until it reaches the destination shelf location, where it can then be driven laterally towards the shelf.

As compared to a robot that is only steered in an arc, or in which the robot is otherwise turned (e.g. rotated) in order to change the robot's distance from the shelf, the steerable drive mechanism 318 allows the robot to maintain the orientation of information readers/sensors, distance sensors, and other navigational equipment with the shelf. Furthermore, unlike a scenario in which a robot may be only steered in an arc, or otherwise turned, the steerable drive mechanism 318 allows the elevator platform 314 and gantry 320 to remain aligned with the shelf. For example, the edge of the elevator platform 314 can be maintained substantially parallel with the edge of the shelf, and the gantry 320 can be maintained substantially perpendicular with the edge of the shelf. According to some embodiments, the robot may be steered by a combination of turning (e.g. steering in an arc) and driving the robot laterally with respect to the shelf.

Referring to FIG. 3D, the elevator assembly 312 is shown with a brake 340. Different types of brakes can be used, for example, depending on the type or implementation a particular type of elevating mechanism 334. As shown in FIG. 3D, the brake 340 comprises a frictional engagement with a leadscrew. In this case, the brake 340 prevents the leadscrew from rotating in the direction that would cause the elevator assembly from being lowered, and/or reduces the rate at which the leadscrew can rotate, thereby slowing the rate at which the elevator assembly is lowered.

According to some embodiments, the brake 340 can allow for heavier packages to be lifted and carried by the robot. For example, when the elevator platform is under load, the brake 340 can reduce the weight born entirely by the elevating mechanism 334. Furthermore, in some cases, the brake 340 can be design so that, if power is lost to the robot (or the elevating mechanism 334), the elevator platform can be lowered slowly and safely by the brake 340 without power to the elevating system 334.

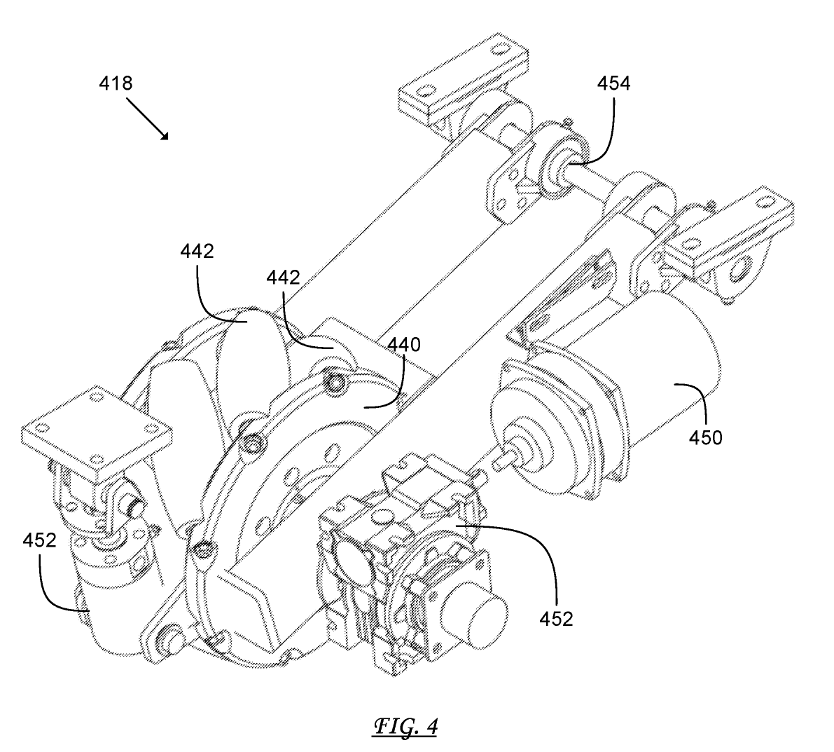

Referring to FIG. 4 there is shown a steerable drive mechanism 418 comprising a Mecanum wheel 440 that is capable of moving the robot in any direction without turning the robot. Other similar wheels may also be used. The Mecanum wheel 440 includes a set of rollers 442 attached to the circumferential plane of the wheel 440, with the rotational axis of the rollers oriented at approximately 45° to the circumference.

Some embodiments may comprise a set of multiple pairs of steerable drive mechanisms 418 (e.g. four or eight wheels). When all of the wheels are driven in the same direction with the same speed, the robot generally moves forwards or backwards. However, in the case of four or eight wheels, when the wheels are divided into subsets of two wheels each, then the robot can be moved in any direction. For example, two diagonally-opposed wheels are driven in the opposite direction as the other two diagonally-opposed wheels, the result is that the robot is driven sideways (i.e. laterally). When two wheels on the same side are driven in the opposite direction as the wheels on the opposite side, the result is that the robot is rotated.

The steerable drive mechanism 418 also includes a drive motor 450 and a gearbox 452 for driving the Mecanum wheel 440. As shown in the example of FIG. 4, the drive motor 450 and gearbox 452 drive the single wheel 440 (e.g. independently of other wheels that may be used) in order to provide the steering capabilities previously described. In other embodiments, a single drive motor may be used to drive more than one wheel.

The drive motor 450 and/or the gearbox 452 may be controlled by the steerable drive system, such as with the onboard computer and/or with any or all of the warehouse navigation system, the aisle navigation system, and the storage location navigation system.

The steerable drive mechanism 418 may, in some cases, comprise a suspension in order to enhance the driving and steering capabilities of the robot, for example, when carrying a heavy payload and/or when driving on an uneven surface. As shown in the example of FIG. 4, the suspension is provided by a cylinder 454 that allows the steerable drive mechanism 418 to move about a pivot 454.

In other embodiments, the steerable drive mechanism 318 may comprise individual steerable drive wheels. For example, each wheel may have an independent drive (such as a motor), and may be able to pivot in order to provide steering. In this case, when all of the steerable drive wheels are aligned in a particular direction, the robot can be driven in that direction. For example, if all of the wheels are aligned in a forwards direction, then the robot 300 can be driven in a forwards direction. Subsequently, the individual steerable drive wheels can be pivoted (e.g. 90 degrees), and the robot 300 can be driven sideways without rotating the robot 300. In some cases, it may be preferred to use four or more steerable drive wheels.

Furthermore, in some embodiments, the steerable drive mechanism 318 may comprise wheels that can be driven in multiple directions, so as to tilt the robot (e.g. lower down the front wheels on a suspension by coordinating the drive between the front and rear wheels, or, similarly, lowering one side of the robot by coordinating the drive between the left and right wheels).

While the above description identifies the benefits of using the forward-backwards drive as well as the sideways (i.e. lateral) drive, it should be noted that the steerable drive mechanism 318 may also be used to make fine adjustments to the orientation of the robot 300 by using the rotational drive mode as well.

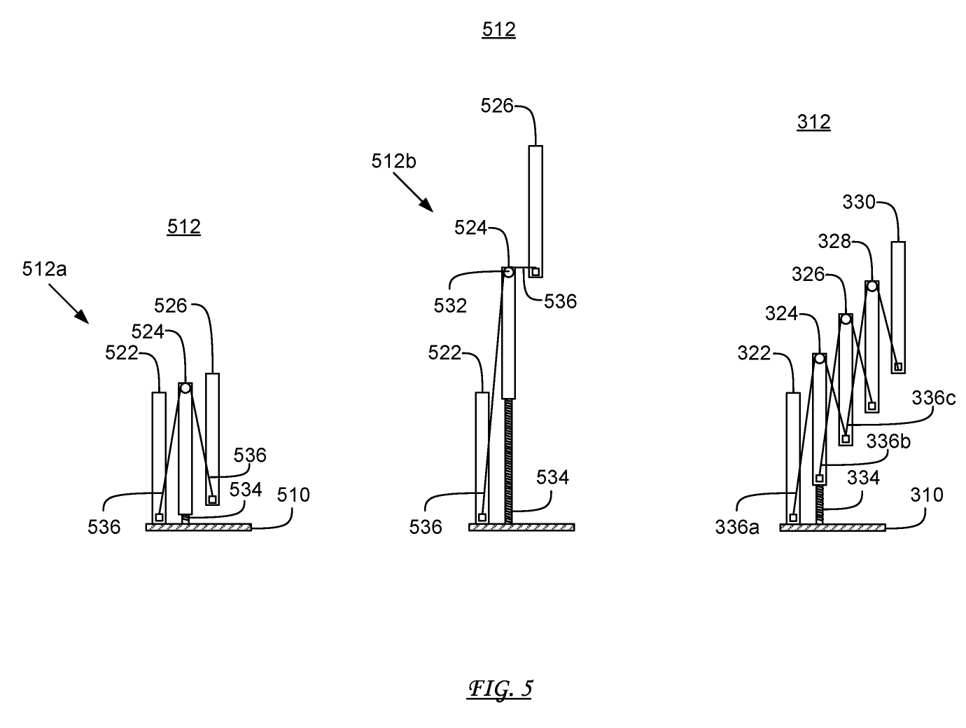

Referring to FIG. 5, there are shown elevator assemblies 312 and 512 according to some embodiments. The elevator assembly 512 is shown in both a lowered position 512a as well as a raised position 512b. Elevator assemblies are examples of vertical member and pulley-and-cable assemblies that can be used along with an actuator.

The elevator assembly 512 comprises a first vertical member 522 attached to a base 510, a second vertical member 524, and a third vertical member 526. The top of the second vertical member 526 includes a pulley 532. The bottom of the second vertical member 524 is supported by the base 510 via an elevating assembly 534 (such as a leadscrew drive).

The first end of a cable 536 is attached to the first vertical member 522.

The cable extends over the top of the pulley 532 attached to the second vertical member 524. The second end of the cable 536 extends from the top of the pulley 532 and is fixed to the third vertical member 526.

In operation, as the elevating mechanism 534 is raised, and a vertical force is exerted upwards on the second vertical member 524, the pulley 532 draws the cable 536 upwards, which in turn draws the third vertical member 526 upwards. In this way, the elevator assembly 512 can be transitioned from the lowered position 512a to the raised position 512b. The elevator assembly 512 can also be transitioned from the raised position 512b to the lowered position 512a by lowering the elevating mechanism 534, thereby lowering the second vertical member 526, which lowers the third vertical member 526 by virtue of gravity and the pulley 532 and cable 536 assembly.

An elevator assembly may comprise other actuators for effecting a vertical force on the second vertical member 524, such as a pneumatic or hydraulic actuators, or cable (and/or chain) hoist. Regardless of the type of actuator used for effecting a vertical force on the second vertical member 524, it is only necessary for the second vertical member 524 to be displaced by its length vertically in order for the entire elevator assembly to be raised to a height that is a multiple of the height of the second vertical member 524 on its own.

The elevator assembly 512 may be scaled by including additional vertical members (not shown). In one such scaling scenario, each of the vertical members, except for the first and last vertical members, includes a pulley alternately on the top or bottom of the vertical member. In some cases, it is necessary to have an odd number of vertical members in order to ensure the proper operation of the elevator assembly 512.

The elevator assembly 312 is a variation on the elevator assembly 512, and operates according to similar principles. One difference between the elevator assembly 312 and the elevator assembly 512 is that the elevator mechanism 312 includes multiple cables.

The elevator assembly 312 comprises a first vertical member 322 attached to a base 310, a second vertical member 324, a third vertical member 326, a fourth vertical member 328, and a fifth vertical member 330. Top of each of the second vertical member 324, the third vertical member 326, and the fourth vertical member 328 includes a pulley. The bottom of the second vertical member 324 is supported by the base 310 via an elevating mechanism 334.

The elevator assembly 312 comprises a first cable 336a, a second cable 336b, and a third cable 336c. The first cable 336a extends from the first vertical member 322, over the pulley on the second vertical member 324, and attaches to the third vertical member 326. The second cable 336b extends from the second vertical member 324, over the pulley on the third vertical member 326, and attaches to the fourth vertical member 328. The third cable 336c extends from the third vertical member 326, over the pulley on the fourth vertical member 328, and attaches to the fifth vertical member 330.

In operation, as the elevating mechanism 334 is raised, and a vertical force is exerted upwards on the second vertical member 324, the multiple pulley and cable assemblies draw the vertical members so that the elevator assembly 312 is transitioned from a lowered position to a raised position.

The elevator assembly 312 may be scaled by including additional vertical members (not shown). In one such scaling scenario, each of the vertical members except for the first and last vertical members includes a pulley. As such, the elevator assembly 512 may be scaled by adding any number of vertical members.

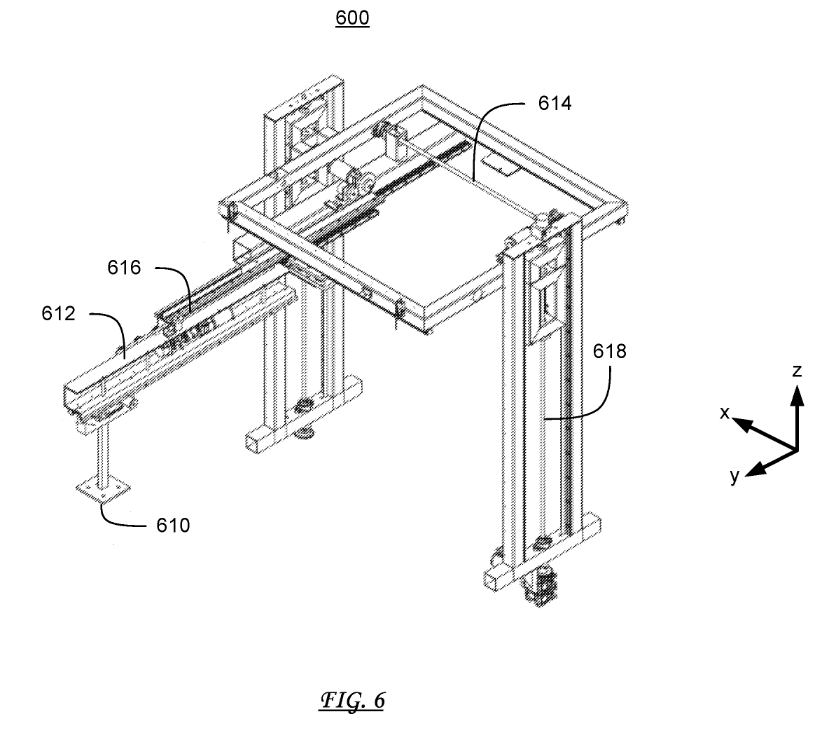

Referring to FIG. 6, there is shown a gantry 600 according to some embodiments. The gantry 600 includes an end effector 610 on a gantry arm 612. The end effector 610 can be moved in three dimensions by way of an x-direction actuator 614, a y-direction actuator 616, and a z-direction actuator 618.

Various types and configurations of the end effector 610 are possible, and an appropriate type or configuration of the end effector 610 may be selected depending on application, type, weight, shape, and dimensions of the package, so that the end effector 610 can hold and lift the package onto or off of the elevator platform.

The end effector 610 may include a passive or active suction device for holding and lifting a package. In such a case, the end effector 610 may include its own extension mechanism (e.g. in the z direction), such as a scissor lift. In other cases, the end effector 610 may include a rigid-chain actuator offset as well as multiple x-direction, y-direction, and z-direction and pitch/skew/yaw motion capabilities.

Alternatively, or additionally, the end effector 610 may include an articulating robot style arm with an appropriate manipulator. For example, the manipulator may include a grasping or clenching jaw or claw for grasping the package.

For example, the manipulator may include an adhesive agent or fastener. For example, the manipulator may include a piercing or ingress mechanism for piercing the surface of the package.

Furthermore, the end effector 610 may include a side-load gantry for sliding the package onto or off of the elevator platform.

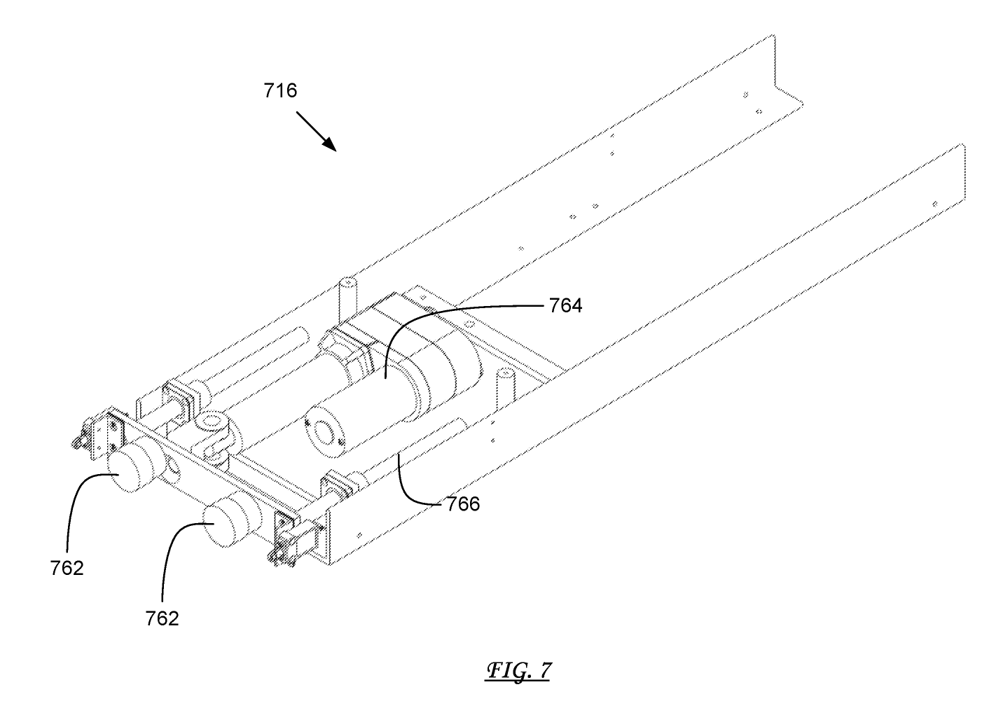

Referring to FIG. 7, there is shown an engagement mechanism 716 according to some embodiments. Whereas the engagement mechanism 316 depicted in FIG. 3A comprises a mechanical hook for attaching to a shelf, the engagement mechanism 716 comprises an electromagnet 762.

The engagement mechanism 716 may be attached to the elevator platform (e.g. elevator platform 314) according to some embodiments. The engagement mechanism may be attached to the elevator platform (e.g. on the underside of the elevator platform) so that, when the elevator platform is raised by the elevator assembly, the engagement mechanism 716 is also raised. As such, the engagement mechanism is able to engage with a shelf at a height determined by the height of the elevator platform at any particular time. For example, when the elevator platform has been raised to the full extent of the elevator assembly, the engagement mechanism 716 can engage with the shelf at the height of the elevator platform, thereby contributing to the stability of the robot, and increasing the weight limit for a package, and/or increasing the height to which the elevator assembly can be extended while carrying a package.

The engagement mechanism 716 may further comprise a linear actuator 764 for extending the electromagnet 762 towards (or retracting from) a shelf. Furthermore, the engagement mechanism may include a guide rail 766 to assist in guiding the electromagnet 762 towards the shelf with which it is to engage. According to some embodiments, the electromagnet 762 and/or the linear actuator 764 may be controlled by the onboard computer and/or the shelf engagement system, which may include coordination with any of the navigation systems such as the storage-location navigation system.

According to some embodiments, as best shown in FIG. 3C, the engagement mechanism 316 may comprise a mechanical hook. Similarly, the engagement mechanism may comprise a clamp or claw. In some embodiments, the engagement mechanism 316 may also comprise a magnet, either on its own, or in combination with a mechanical hook, clamp, or claw. Furthermore, an engagement mechanism such as engagement mechanism 316 attached to the base of the robot may be used along with an engagement mechanism such as engagement mechanism 716 attached to the elevator platform.

Depending on the type of engagement mechanism used, the shelf may comprise a complementary dock for the engagement mechanism. The complementary dock may comprise a magnet or metal pad, such as in the case of an engagement mechanism 716 that includes an electromagnet 762. In other embodiments, the engagement mechanism may be designed so that it can be clamped to an existing shelf (e.g. standard waterfall shelving) without the need for a complementary docking member on the shelf or a shelf that is purpose-built for receiving a particular engagement mechanism.

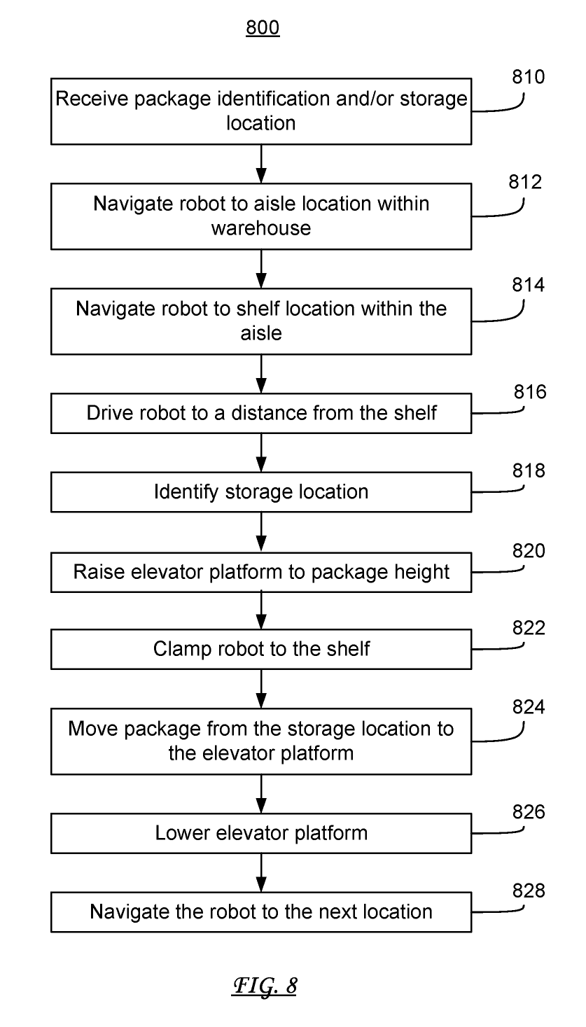

Referring to FIG. 8, there is shown a method 800 for lifting a package off of a shelf, according to some embodiments.

The method 800 begins at the step 810, when package identification or shelf-location information is provided to an autonomous robot. For example, the robot may receive the information from an inventory or order-management system.

During the step 812, the robot navigates to an aisle location that is associated with the package identification or shelf-location information received during the step 810. In some cases, a warehouse navigation system may be used to navigate the robot to the aisle location during the step 812. Various types of warehouse navigation systems are contemplated.

For example, the warehouse navigation system may be a vision-based navigation system. For example, a vision-based navigation system may comprise navigational targets placed throughout the warehouse, and the robot may be equipped with an optical sensor for capturing images of the navigational targets. The navigational targets may include navigational information that can be used by the warehouse navigation system and the robot for navigating the robot through the warehouse.

In some cases, the warehouse navigation system may comprise a track (e.g. a metal track) embedded in the warehouse floor, and/or a paint or tape applied to the floor. The robot may be equipped with an appropriate sensor for detecting the track, such as an electric and/or magnetic sensor for detecting a metal track, or an optical sensor for detecting paint or tape applied to the floor. The warehouse navigation system and the robot may use the track, paint, and/or tape for navigating the robot through the warehouse.

Once the robot has reached the aisle location that is associated with the package, then, during the step 814, the robot is navigated to the shelf location (within the aisle location) associated with the package. An aisle navigation system may be used to navigate the robot to the storage location. Various types of aisle navigation systems are contemplated.

For example, the aisle navigation system may comprise a distance sensor such as an ultrasonic sensor and/or a laser for determining the distance between the robot and the shelf. In such a case, the ultrasonic laser can be used to determine whether the robot is traveling parallel to the shelf, as well as whether the robot is an appropriate distance from the shelf in respect of other functions. Furthermore, a 3D camera may be used to monitor the shelf location as a part of the aisle navigation system.

The aisle navigation system and/or the storage-location navigation system may comprise a reader or sensor for reading or sensing location identifiers 126 attached to the shelf. In some cases, this may represent a different use of a reader or scanner (as a part of the aisle navigation system) as compared to the use of the reader or scanner that is used as a part of the storage-location navigation system. A single reader or sensor may be included on the robot to be used with one or both of the aisle navigation system and the storage-location navigation system. Alternatively or additionally, the storage-location navigation may also include a vision-based system, such as SLAM technology that uses 3D cameras and/or laser guidance and a map of the shelf and storage location.

When the aisle navigation system uses a reader or sensor (e.g. barcode scanner or RFID sensor), the reader or sensor is used to obtain information from the location identifiers 126 that include location information in order for the aisle navigation system to determine where the robot is currently located within an aisle location. For example, bar code labels or RFID tags may be placed on the shelf, or elsewhere within the aisle location, in order to provide location information to the aisle navigation system. The aisle navigation system may use barcode labels or RFID tags that include information pertaining to a package or storage location at the shelf location. In this case, the barcode labels or RFID tags may be the same bar code labels or RFID tags as used by the storage-location navigation system, and the aisle navigation system may use the information pertaining to the package or storage location in order to determine location information, based on known location information associated with the package or storage location.

In some cases, the aisle navigation system may use other technologies in addition to, or in place of the location identifiers 126. For example, small signs may be used, as well as optical character recognition technology and RFID technology. In these cases, appropriate (e.g. corresponding) sensors may be required as a part of the aisle navigation system.

The aisle navigation system may comprise a 3D scanner (e.g. optical and/or laser scanner) to track a course along the shelf. Alternatively, or additionally, the aisle navigation system may comprise a vision-based system that tracks distance to a shelf and/or the location within an aisle location, for example, using navigation targets or signs, or using laser-based navigation techniques. In some cases, the aisle navigation system may comprise floor-mounted guidance, such as may use a wire, paint, tape, or a mechanical guide or track.

Once the robot has been navigated to the desired shelf location, then, during the step 816, the robot is driven to a distance from the shelf (e.g. a shelf-access distance). The distance from the shelf may be determined using the distance sensor of the aisle navigation system, or a distance sensor of the storage-location navigation system.

The robot may be equipped with a steerable drive mechanism as previously described. As such, during the step of 814, the robot may drive along the length of the aisle or shelf until it gets to the shelf location. Then, during the step of 816, the robot may drive towards the shelf (i.e. perpendicular to the aisle; lateral to the direction during the step of 814) without rotating (e.g. steering) the body of the robot itself. In particular, it is the elevator platform and/or a information reader/sensor (e.g. barcode scanner, RFID sensor) and/or distance sensor that remains in a constant orientation with the shelf (e.g. does not rotate) while the robot is driven to the shelf-access distance during the step of 816.

Once the robot is at the shelf location (during the step 814), and has been driven to within the shelf-access distance (during the step 816), then, during the step 818, the storage location is identified. In some cases, the storage-location navigation system may comprise a reader or sensor such as a barcode scanner for scanning a barcode, or an RFID sensor for reading an RFID tag corresponding to the package at the shelf location.

For example, the barcode scanner or RFID sensor (or other location identifier) may be used to scan a barcode or RFID tag placed on the shelf at the shelf location. The information obtained from the barcode label or RFID tag may be used to identify information such as the height of the package on the shelf, and details about the package such as the weight, size, shape, dimensions, and color. Furthermore, the barcode label or RFID tag may identify the package so that the storage-location navigation system can verify that the robot has indeed arrived at the correct shelf location corresponding to the desired package.

The storage-location navigation system may comprise pre-applied location identifiers placed at the shelf location, and/or placed with a known offset in the x-direction and/or y-direction. Furthermore, the storage-location navigation system may comprise waypoints and encoder-based positioning, and/or a vision-based system for determining the storage location.

In some cases, a single shelf location may include different location identifiers corresponding to different storage locations. For example, if a shelf location is configured to have four storage locations stacked vertically every five feet, then there may be five location identifiers at the shelf location, each corresponding to one of the storage locations. Therefore, the storage-location navigation system determines which of the location identifiers corresponds to the desired package (and storage location).

Once the storage location has been identified (and/or verified) during the step 818, then, during the step 820, the elevator assembly raises the elevator platform to a height determined by the height provided in association with the storage location during the step 818.

Once the elevator platform has been raised to the appropriate height for retrieving the package from the storage location, then, during the step 822, the robot is clamped to the shelf using the robot's engagement mechanism. The clamp may serve to provide stability to the robot once the elevator assembly is raised to the height of the storage location on the shelf, thereby increasing the height to which the elevator platform can be raised. The distance sensor of the aisle navigation system may be used to ensure that the robot is at an appropriate distance from the shelf (e.g. a shelf-access distance) such that the engagement mechanism on the robot can engage with the shelf.

During the step 824, the package is moved from the storage location onto the elevator platform.

A gantry may be used to move the package from the storage location onto the elevator platform. After the package has been moved from the storage location to the elevator platform, then, during the step 826, the elevator platform is lowered, the clamp is released from the shelf, and the robot is configured to drive with the package on the elevator platform.

During the step 828, the robot is navigated to its next location. This may be done using one or both of the aisle navigation system and the warehouse navigation system. The next location to which the robot is driven may be a subsequent pickup location (e.g. another storage location where a subsequent package is placed onto the elevator platform), or a drop-off location for the package that is currently on the elevator platform.

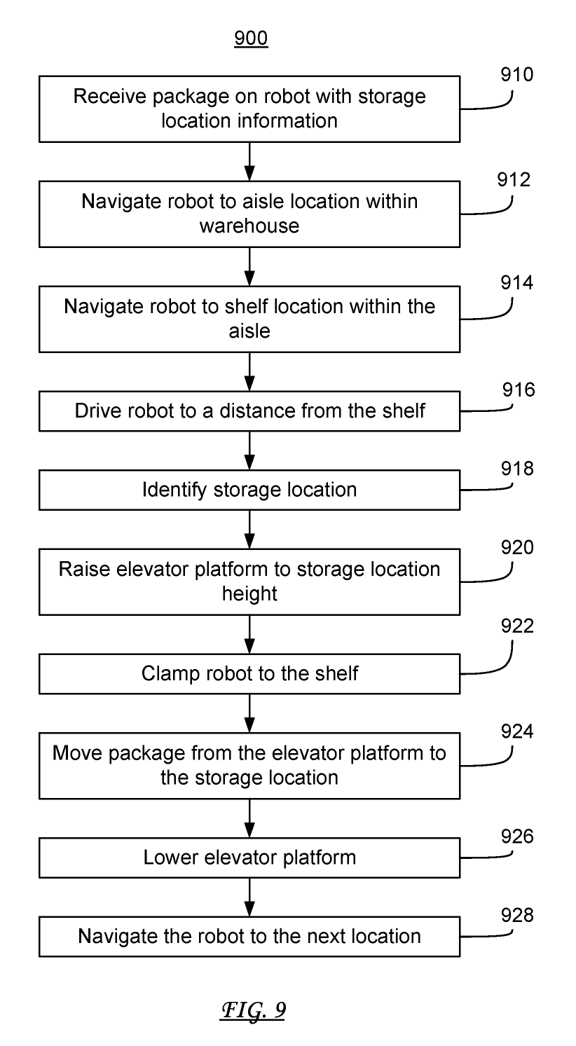

Referring to FIG. 9, there is shown a method 900 for stacking a package on a shelf, according to some embodiments.

The method 900 is, in many ways, similar to the method 800 depicted in FIG. 8, although it generally performs the inverse function. That is, whereas the method 800 is used for retrieving a package from a storage location, the method 900 is used for placing a package into a storage location.

The method 900 begins at the step 910, when a package is received on an autonomous robot. For example, the step 910 may occur when a new package is identified for storage in a particular storage location, or, the step 910 may correspond to the state of the robot after the step 826 of the method 800. The subsequent steps 912 to 928 generally correspond to the steps 812 to 828 of the method 800, and the same details of the steps 912 to 928 will not be repeated here. It should be noted, however, that for the steps 912 to 922, the package is located on the elevator platform of the robot, and that for the steps 926, the package is located in the storage location. During the step 924, the package is moved from the elevator platform to the storage location, for example, using a gantry.

While the above description provides examples of one or more apparatus, methods, or systems, it will be appreciated that other apparatus, methods, or systems may be within the scope of the claims as interpreted by one of skill in the art.

1. A robot for stacking a package on a shelf, comprising
a base;
an elevator assembly comprising an elevator platform and an elevator mechanism for elevating the elevator platform;
an engagement mechanism for attaching the robot to a shelf adjacent the base;
a steerable drive mechanism attached to the base for driving and steering the robot; and
an on-board computer having at least one processor configured to:
communicate with a warehouse navigation system;
communicate with an aisle navigation system;
communicate with a storage location navigation system;
provide instructions to the steerable drive mechanism to drive and steer the robot based on communications with at least one of the warehouse navigation system, the aisle navigation system, and the storage location navigation system; and
provide instructions to the elevator assembly to elevate the elevator platform based on communications with the storage location navigation system.

2. The robot of claim 1, wherein the steerable drive mechanism is configured to drive and steer the robot in a forward direction at a first time and a lateral direction at a second time without rotating the base relative to the shelf.

3. The robot of claim 1, wherein the elevator mechanism comprises:
a first vertical member attached to the base;
a second vertical member slidably coupled to the first vertical member, the second vertical member having a pulley;
a third vertical member slidably coupled to the second vertical member;
a cable passing over the pulley and having a first end fixed to the base and a second end fixed to the third vertical member; and
an elevating mechanism attached to the base for exerting an upwards force on the second vertical member;
such that, when the elevating mechanism exerts the upwards force on the second vertical member, the third vertical member is drawn upwards by the cable.

4. The robot of claim 1, wherein the elevator mechanism comprises at least one helical band actuator.

5. The robot of claim 1 wherein the elevating mechanism is selected from the group comprising a leadscrew drive, a pneumatic actuator, a hydraulic actuator, a rigid chain actuator, and a telescoping linear actuator.

6. The robot of claim 1, wherein the elevating mechanism is a rigid chain actuator. The robot of claim 1, wherein the elevating mechanism is a telescoping linear actuator.

8. The robot of claim 2, wherein the steerable drive mechanism comprises a Mecanum wheel.

9. The robot of claim 2, wherein the steerable drive mechanism comprises at least three steerable drive wheels.

10. The robot of claim 1, wherein the aisle navigation system comprises a sensor for detecting a distance between the robot and the shelf.

11. The robot of claim 1, further comprising a storage-location navigation system comprising a sensor for obtaining information associated with the package.

12. The robot of claim 1, further comprising a gantry for loading the package on the elevator platform.

13. A method for retrieving a package from a storage location on a shelf using a robot, comprising:
navigating the robot to a shelf location corresponding to the storage location within an aisle location;
driving the robot to a shelf-access distance from the shelf;
identifying the storage location;
raising an elevator platform to a height associated with the storage location using an elevator assembly;
engaging the robot with the shelf; and
moving the package from the storage location to the elevator platform using a gantry.

14. The method of claim 13, wherein the step of driving the robot to the shelf-access distance comprises driving the robot perpendicular to the shelf without rotating the elevator platform relative to the shelf.

15. The method of claim 13, wherein the elevator assembly comprises a first vertical member, a second vertical member having a pulley, a third vertical member, a cable passing over the pulley having a first end fixed to the first vertical member and a second end fixed to the third vertical member, and an elevating mechanism for exerting an upward force on the second vertical member; and
wherein the step of raising the elevator platform comprises using the elevating mechanism to apply the upward force on the second vertical member such that the third vertical member is drawn upwards by the cable.

16. The method of claim 13, wherein the step of driving the robot to the shelf-access distance comprises using a sensor to measure a distance from the robot to the shelf.

17. The method of claim 13, wherein the step of identifying the storage location comprises using a sensor to obtain information from a location identifier associated with at least one of the storage location and the package.

18. The method of claim 13, further comprising the preliminary step of using a vision-based warehouse navigation system to navigate the robot from a first location to the aisle location.

19. A method for placing a package into a storage location on a shelf from a robot, comprising:
receiving the package on an elevator platform of the robot;
navigating the robot to a shelf location corresponding to the shelf within an aisle location;
driving the robot to a distance from the shelf using an aisle navigation system;
identifying the storage location using a shelf-identification system;
raising the elevator to a height associated with the storage location using an elevator assembly;
engaging the robot with the shelf using an engagement mechanism; and
moving the package from the elevator platform to the storage location using a gantry.

20. The method of claim 19, wherein the step of driving the robot to the distance from the shelf comprises driving the robot perpendicular to the shelf without rotating the elevator platform relative to the shelf.

21. The method of claim 19, wherein the elevator assembly comprises a first vertical member, a second vertical member having a pulley, a third vertical member, a cable passing over the pulley having a first end fixed to the first vertical member and a second end fixed to the third vertical member, and an elevating mechanism for exerting an upward force on the second vertical member; and
wherein the step of raising the elevator platform comprises using the elevating mechanism to apply the upward force on the second vertical member such that the third vertical member is drawn upwards by the cable.

22. The method of claim 19, wherein the step of driving the robot to the shelf-access distance comprises using a sensor to measure a distance from the robot to the shelf.

23. The method of claim 19, wherein the step of identifying the storage location comprises using a sensor to obtain information from a location identifier associated with at least one of the storage location and the package.

24. The method of claim 19, further comprising the preliminary step of using a vision-based warehouse navigation system to navigate the robot from a first location to the aisle location.
